(19) United States
(12) Patent Application Publication
(10) Pub. No.: US 2012/0279635 A1
(43) Pub. Date: Nov. 8, 2012

(54) METHODS FOR PRODUCING A PART MADE FROM A COMPOSITE MATERIAL, OBTAINED BY DEPOSITING LAYERS OF REINFORCING FIBERS URGED ONTO A MANDREL

(75) Inventors: Richard Masson, Les Loges En Josas (FR); Patrick Dunleavy, Palaiseau (FR); Bertrand Desjoyeaux, Sainte Adresse (FR)

(73) Assignees: AIRCELLE, GONFREVILLE-L'ORCHER (FR); MESSIER-BUGATTI-DOWTY, VELIZY VILLACOUBLAY (FR)

(21) Appl. No.: 13/511,750

(22) PCT Filed: Dec. 16, 2010
(86) PCT No.: PCT/EP2010/007659

§ 371 Date: May 24, 2012

(30) Foreign Application Priority Data
Dec. 16, 2009 (FR) 09 06154

(51) Int. Cl. B29C 70/32

(52) U.S. Cl. 156/149

(57) ABSTRACT

The invention relates to a method of fabricating a composite material part in which one or more layers of braided, or woven, or indeed draped reinforcing fibers are applied onto a mandrel having the general shape of a body of revolution. After one or more layers have been applied onto the mandrel, an operation is performed of winding at least one tie helically around and along the assembly constituted by the mandrel and each layer of reinforcing fibers that it carries, so as to press each layer of reinforcing fibers against the mandrel. The invention relates to fabricating composite material parts such as beams, connecting rods, or arms made out of carbon fibers.

The invention relates to fabricating composite material parts obtained by applying a plurality of layers of reinforcing fibers onto a mandrel. The layers may be woven, braided, or draped layers of carbon fibers that are bonded to one another, e.g. by injecting resin.

### BACKGROUND OF THE INVENTION

In such a fabrication method, e.g. as used for making a composite material arm, the mandrel is a part that may be solid or hollow, and that is also known as a core. It mainly constitutes a support having an outside shape that is closely followed by the layers of reinforcing fibers when they are applied thereagainst, so that the final part presents a shape that corresponds to a desired shape.

In practice, the layers of reinforcing fibers may be applied onto the mandrel by using a braiding machine such as the machine referenced 1 in FIG. 1.

The mandrel 2 is then installed in the braiding machine 1 which essentially comprises a ring 3 carrying a series of reels of reinforcing fiber on its rear face. The reinforcing fibers 4 join one another in a region situated substantially on an axis AX that is normal to the ring 3. When the braiding cycle is started, the mandrel 2 is moved along the axis AX, thereby causing a stocking of fibers to be braided, which stocking is pressed against the outside face of the mandrel 2.

The travel speed of the mandrel relative to the ring is adjusted so that the fibers are braided to become oriented at an angle having a predetermined value such as sixty degrees relative to the axis AX. Several passes are performed in this way in order to build up a plurality of layers of braided fibers surrounding the mandrel.

The assembly constituted by the mandrel and the various layers of fibers is subsequently placed in a mold. Resin is then injected to impregnate the layers of fibers, after which a baking cycle is launched, so that the assembly constituted by the fiber layers and the resin constitutes a rigid whole.

In practice, it is desirable for the layers of fiber to be pressed as well as possible against the mandrel that carries them so as to obtain firstly a good geometrical match between the finished part and the mandrel, and secondly so as to obtain as great as possible a density of reinforcing fibers in the finished part so that the ratio of mechanical strength over weight is optimized.

The extent to which the layers of braided fibers are pressed against the mandrel is optimized by acting on the level of tension in the reinforcing fibers during the braiding operation.

In general, the extent to which the layers of fibers are pressed against the mandrel is determined by the tension in the fibers, by their orientation relative to the axis AX, and by the travel speed of the mandrel along the axis AX.

In the example of FIG. 1, the layers of reinforcing fibers are applied during a braiding operation. However, in other methods, the layers of reinforcing fibers may be in the form of a prefabricated fiber fabric for impregnating with resin, or indeed in the form of preimpregnated drapes.

When fabric is used, it is put into place by an operator who simultaneously impregnates it with resin in order to press it against the mandrel. When using preimpregnated drapes, pieces are put into place on the mandrel in analogous manner by an operator without it being necessary to proceed with impregnating them with resin.

Thus, in these last two examples, the question of pressing the fibers down is determined essentially by the skill of the operator putting the layers of reinforcing fibers into place, such that, in an industrial fabrication context, it is not certain that this pressing-down operation will be properly performed.

### OBJECT OF THE INVENTION

The object of the invention is to propose a solution for improving the pressing-down of layers of reinforcing fibers that are applied against the mandrel.

### SUMMARY OF THE INVENTION

To this, the invention provides a method of fabricating a composite material part in which one or more layers of reinforcing fibers that are braided or woven or else draped are applied onto a mandrel that extends in a longitudinal direction and that presents a cross-section that is defined by a closed outline, the method being characterized in that it includes, after applying one or more layers on the mandrel, an operation of applying at least one tie that is wound helically around and along the assembly constituted by the mandrel and each layer of reinforcing fibers that it carries, in order to press each layer of reinforcing fibers against the mandrel.

According to the invention, the layer(s) of reinforcing fibers applied against the mandrel is/are pressed down by the taping operation, so there is no longer any need to proceed with complex and time-consuming adjustments of the tension in the fibers during the operation of applying the layers of braided fibers.

This makes it possible firstly to increase the geometrical match between the finished part and the outside shape of the mandrel, and secondly to increase the density of reinforcing fibers in the part so as to increase its mechanical strength.

The invention also provides a method as defined above, wherein the tie used is in the form of a tape, and is placed flat against the layers of reinforcing fibers carried by the mandrel.

The invention also provides a method as defined above, wherein the consecutive turns of each wound tie are spaced apart from one another.

The invention also provides a method as defined above, wherein a new layer of reinforcing fibers is applied over one or more layers on which at least one tie has been wound, and wherein at least one tie that has been wound is unwound so as to be removed progressively as the new layer(s) is/are applied.

The invention also provides a method as defined above, wherein the winding operation comprises winding a tie in the form of a tape, and secondly winding a tie in the form of a yarn.

The invention also provides a method as defined above, wherein the tie in the form of a tape is removed before applying a new layer of reinforcing fibers.

The invention also provides a method as defined above, wherein at least two ties are wound in opposite directions around the assembly constituted by the mandrel and the layer(s) of reinforcing fibers that it carries.

The invention also provides a method as defined above, wherein at least one tie wound on the assembly constituted by the mandrel and the layers of reinforcing fibers that it carries is constituted by fibers of the same kind as the reinforcing fibers of the layers applied against the mandrel.

The invention also provides a method as defined above, wherein at least one tie is wound around and along the assembly progressively as a layer of reinforcing fibers is being deposited on the assembly.

The invention also provides a method of fabricating a composite material part in which one or more layers of reinforcing fibers that are braided or woven or else draped are applied onto a mandrel that extends in a longitudinal direction and that presents a cross-section that is defined by a closed outline, prior to injecting resin into said layers and polymerizing the resin, the method being characterized in that, prior to injecting the resin, it includes one or more operations of pressing each layer of reinforcing fibers against the mandrel, each operation being performed by an apparatus having a frame rotating about the mandrel and carrying a presser member applied at least in part radially against the assembly formed by the mandrel and each layer that it carries, while being free to rotate relative to the frame and around an axis parallel to the longitudinal direction so as to exert a pressing force against each layer that is to be pressed down, which force is oriented radially relative to the longitudinal direction.

The layer(s) of reinforcing fibers applied against the mandrel is/are pressed down by the taping operation, so there is no longer any need to proceed with complex and time-consuming adjustments of the tension in the fibers during the operation of applying the layers of braided fibers.

This makes it possible firstly to increase the geometrical match between the finished part and the outside shape of the mandrel, and secondly to increase the density of reinforcing fibers in the part so as to increase its mechanical strength.

The invention also provides a method as defined above, wherein the presser member is a belt engaged around a set of wheels carried by the frame, a portion of the belt being pressed laterally against a portion of the assembly constituted by the mandrel and each layer that it carries.

The invention also provides a method as defined above, wherein pressing is performed by two apparatuses having respective frames rotating in opposite directions around the assembly constituted by the mandrel and each layer that it carries.

The invention also provides a method as defined above, wherein at least one operation of pressing layers of reinforcing fibers is implemented progressively as a layer of reinforcing fibers is being deposited on the assembly.

### BRIEF DESCRIPTION OF THE FIGURES

FIG. 1 is an overall view showing an operation of braiding carbon fibers around a mandrel.

FIG. 2 is a fragmentary side view of a braiding operation with taping of the invention.

FIG. 3 is an overall view of apparatus for taping the assembly constituted by the mandrel and the layers of fibers that it carries.

FIG. 4 is a diagrammatic side view showing a first implementation of the invention.

FIG. 5 is a longitudinal section view of a finished part showing diagrammatically the multilayer structure that is obtained with the first implementation of the invention.

FIG. 6 is a side view showing diagrammatically a second implementation of the invention.

FIG. 7 is a longitudinal section view of the finished part showing diagrammatically the multilayer structure obtained with the second implementation of the invention.

FIGS. 8 to 10 are side views showing diagrammatically a third implementation of the invention.

FIG. 11 is a longitudinal section view showing a finished part showing diagrammatically the multilayer structure in a third embodiment of the invention.

FIG. 12 is a side view showing diagrammatically a fourth implementation of the invention.

FIG. 13 is a diagrammatic cross-section view of apparatus for implementing a single calendering operation.

FIG. 14 is a diagrammatic cross-section view of apparatus enabling a double calendering operation to be implemented.

FIG. 15 is a side view showing diagrammatically an implementation in which the method of the invention incorporates a calendering operation prior to winding ties.

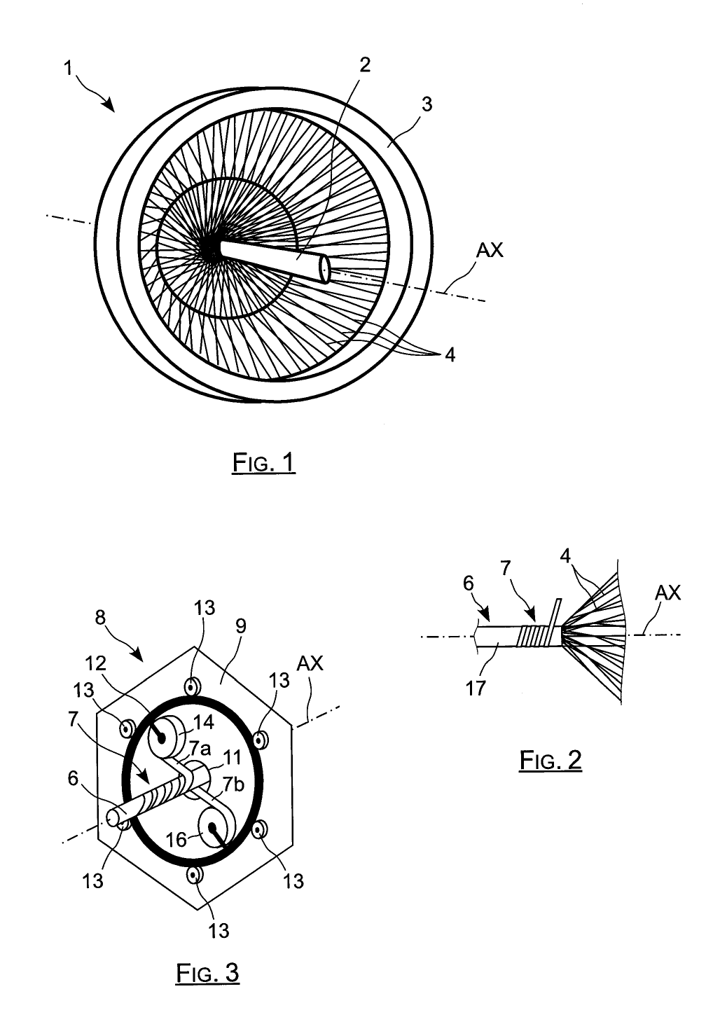

### DETAILED DESCRIPTION OF THE INVENTION

The idea on which the invention is based is to implement the pressing down of layers of reinforcing fibers against a mandrel by winding a tie around them, so as to greatly simplify control over this pressing-down operation.

The mandrel extends longitudinally in a direction AX, presenting a cross-section that is defined by a closed outline that may be elliptical, polygonal, or other. This outline generally defines a side face of the mandrel that is to be covered in reinforcing fibers in order to make up a final part.

As shown diagrammatically in FIG. 2, the operation of winding around the layer(s) of fibers carried by the mandrel may be incorporated with an operation of braiding said layer(s), in such a manner that there is no need to provide for a separate additional stage.

The winding may be performed manually or semi-manually, however it is advantageously implemented by means of apparatus of the kind shown in FIG. 3 where it is given reference numeral 8.

As can be seen in FIGS. 2 and 3, the tie 7 is wound around and along the assembly 6 that is itself made up of the mandrel and the layers that it carries, so as to place the tie in generally helical manner, forming consecutive turns that are spaced apart from one another along the axis AX in this example.

In the example of FIGS. 2 and 3, the tie 7 is in the form of a tape, i.e. it presents a section with an outline that is generally rectangular. The tape 7 is then pressed flat against the layers of reinforcing fibers carried by the mandrel, thereby optimizing retention of the fibers and preventing them from taking up an undulating shape, and on the contrary facilitating obtaining a shape for the fibers that is as regular as possible.

The winding operation may be performed with the apparatus 8 that is shown diagrammatically in FIG. 7, the apparatus then being placed around the axis AX in front of the braiding ring 3 that is not shown in FIG. 3. This configuration enables winding to be performed progressively as a layer of fibers is being deposited.

The apparatus 8 comprises a support plate 9 with a circular central opening 11 centered on the axis AX, and with the assembly 6 passing therethrough. The plate 9 carries a ring 12 centered on the axis AX by means of a set of six wheels referenced 13 that surround the ring while also carrying it. The wheels are themselves carried by the plate 9 and are capable of rotating relative thereto, and they are regularly spaced apart around a circle centered on the axis AX, this circle having a diameter that is slightly greater than the diameter of the ring 12.

The ring 12 is thus engaged inside the circle defined by the wheels 13, and one or more of the wheels is motor-driven so as to cause the ring 12 to rotate about the axis AX when the motor(s) is/are activated.

As can be seen in FIG. 3, the ring 12 also carries two reels 14 and 16 situated so as to be diametrically opposite about the axis AX, each reel being suitable for turning about an axis parallel to the axis AX and relative to the ring 12 that carries it.

In operation, and as shown diagrammatically in FIG. 3, the ring 12 is set into rotation by the motor-driven wheel(s), and at the same time the assembly 6 constituted by the mandrel and the braided fiber layers that it carries is moved along the axis AX so that the two tapes 7a and 7b are unreeled from the reels 14 and 16 respectively and wound helically around the layer of fibers that is being deposited on the assembly 6.

The apparatus of FIG. 3 serves to wind two tapes simultaneously in the same direction, here referenced 7a and 7b, however it could equally well be used to wind a single tape 7, assuming that the appliance is then fitted with only one reel 14.

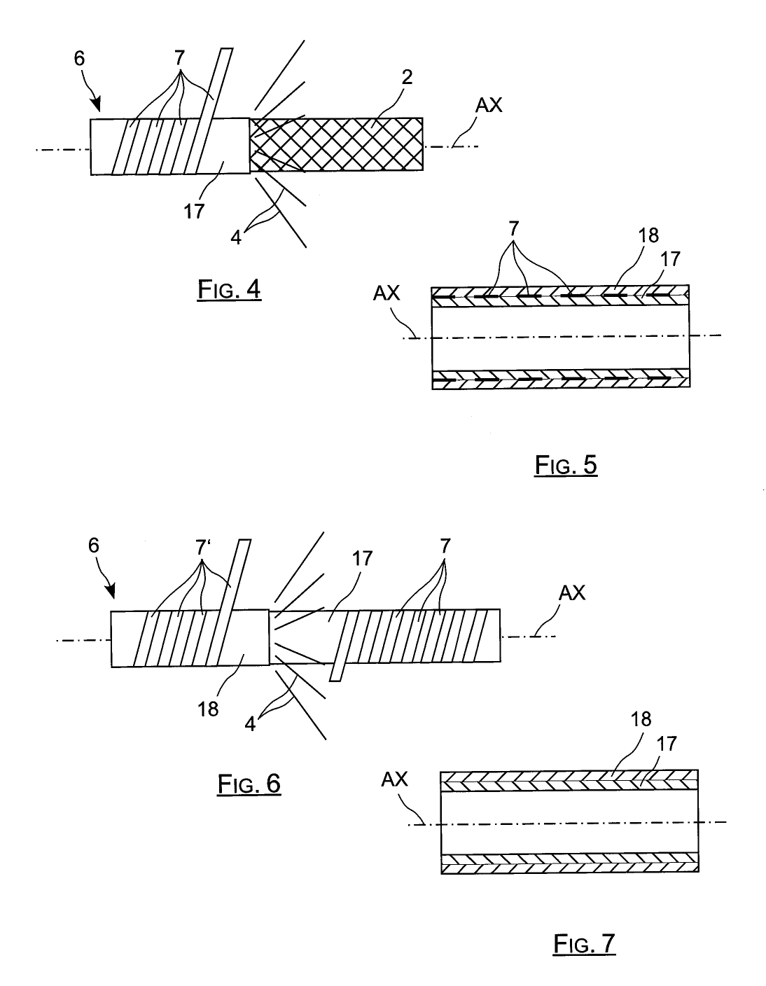

As shown diagrammatically in FIG. 4, the tape 7 may be wound around a first layer 17 of reinforcing fibers 4 that is applied around the mandrel 2 by the braiding machine. Once this first layer 17 has been applied and the tape 7 has been wound around it, a new layer 18 of reinforcing fibers may be applied around the assembly, i.e. over the layer 17 and the tape 7 that surrounds it.

In the resulting structure, and as can be seen in FIG. 5, the two layers 17 and 18 are superposed one on the other, however the tape 7 remains interposed between these two layers where they join each other.

It will readily be understood that it can then be advantageous to use a tape 7 that is made of fibers of the same kind as the reinforcing fibers of the layers 17 and 18 so as to obtain satisfactory cohesion between these two layers after resin has been injected.

In another implementation of the method of the invention, the tape 7 is wound around the layer 17 of reinforcing fibers so as to press the layer against the mandrel 2, however the tape is removed progressively as the new layer 18 of braided fibers is being applied.

As shown diagrammatically in FIG. 6, another tape referenced 7′ is wound around the new layer 18 of reinforcing fibers progressively as this layer is being braided around the assembly constituted by the mandrel and the first layer of reinforcing fibers 17. Depending on circumstances, the outer tape 7′ may be left in place, or it may be removed, as in FIG. 7, which shows the structure resulting from the method of FIG. 6 when the outer tape has been removed.

As can be seen in FIG. 7, because the first tape 7 has been removed before the second braided layer 18 is applied, the two braided layers bear directly against each other so as to optimize cohesion between them once resin has been injected and baked.

As in the example of FIGS. 8 to 11, it is also possible to wind not only a tape 7 around the fiber layer 17, but to wind both a tape 7 and a yarn 7″, in the same direction, so as to leave the yarn 7″ in place after the tape 7 has been removed at the time the second layer 18 of reinforcing fibers is applied. Depending on circumstances, the yarn 7″ may be wound simultaneously with the tape, or it may be wound subsequently, in the gaps between consecutive turns of the tape 7.

The tape 7 may thus serve properly speaking to press the layer 17 against the mandrel 2, while the tie 7″ in the form of a yarn has the function of holding the pressed layer in place after the tape 7 has been removed.

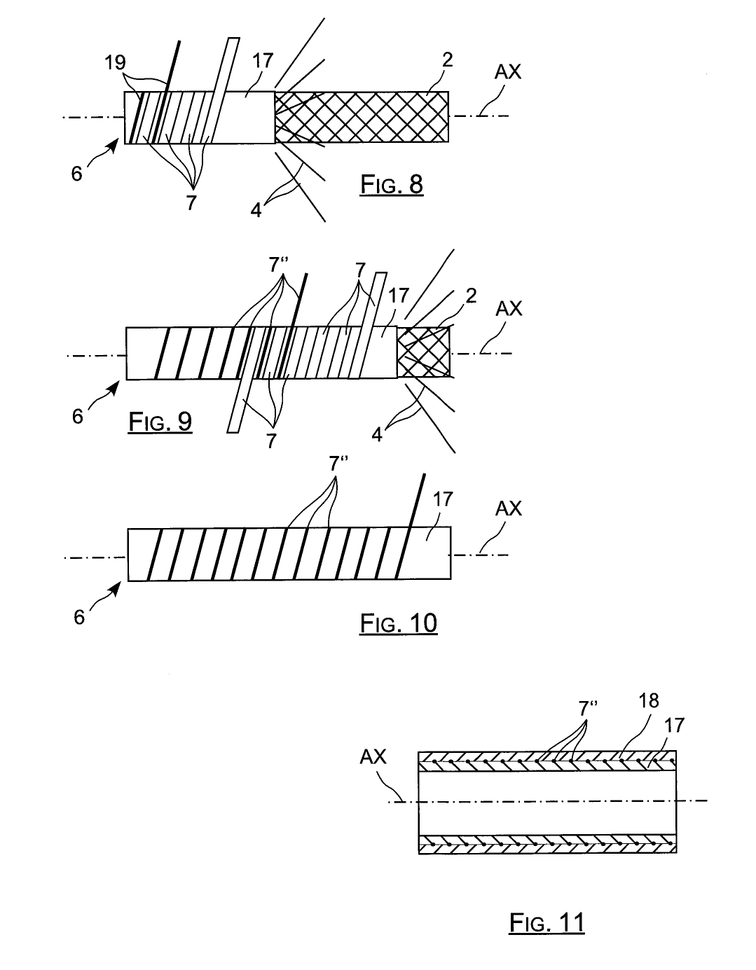

Under such conditions, removing the tape 7 before applying the additional layer 18, which corresponds to FIG. 9, does not run any risk of the layers 17 no longer being pressed against the mandrel.

It follows that in the finished part, only the yarn 7″ remains, thereby guaranteeing that the inner layer 17 is properly pressed down, while also guaranteeing good cohesion between the layers 17 and 18 since the yarn 7″ interposed between these layers presents a surface area that is negligible compared with the total surface area of the junction between these two layers, as can be seen in FIG. 11.

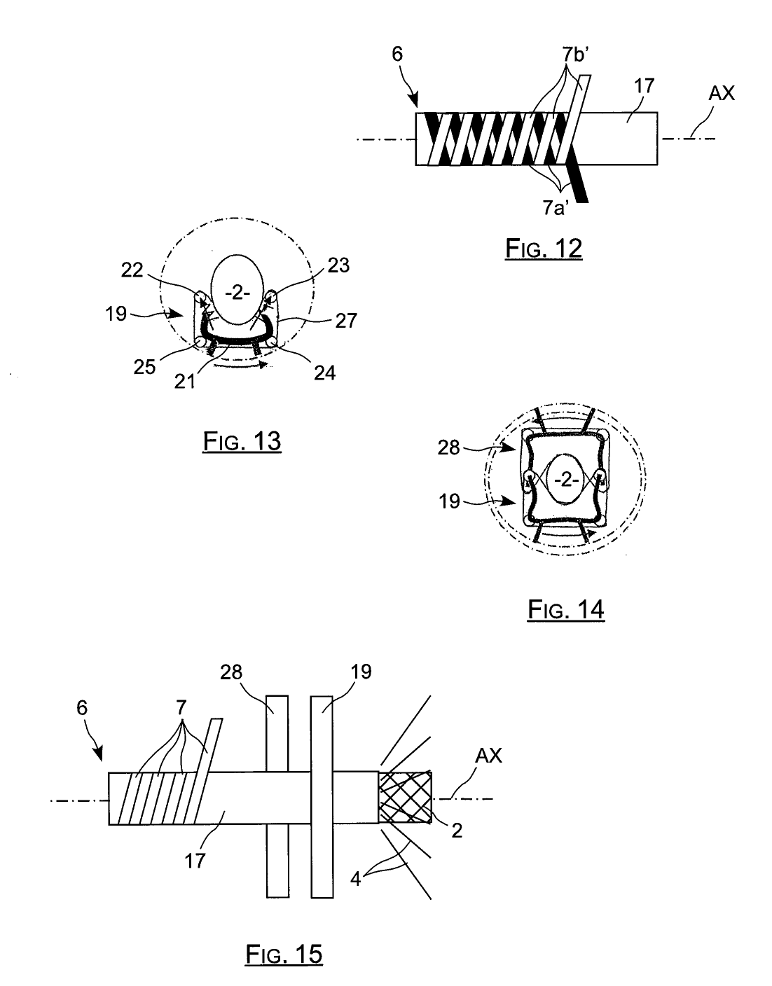

In order to ensure that the tape 7 is wound around the braided layers of reinforcing fibers without disturbing the orientations of those fibers relative to the axis AX, it is possible, advantageously, to wind two tapes in opposite directions, as shown diagrammatically in FIG. 12.

Under such circumstances, the twisting effect exerted by one of the tapes on the layer of reinforcing fibers is compensated by the effect of the opposite twist exerted by the second tape that is wound in the other direction, so that circumferential tension is balanced.

The two tapes that are referenced 7a′ and 7b′ are then, for example, wound by means of two apparatuses of the kind shown in FIG. 3 that are then mounted one in front of the other, in front of the braiding machine 1. Under such circumstances, each apparatus then carries a single reel of tape, and the rings of the two apparatuses are controlled to rotate in opposite directions about the axis AX.

Under such conditions, deflection of the fibers in the reinforcing layers as caused by the operation of winding tapes is minimized.

It should be observed that the implementation of FIG. 12 does not exclude the possibility of also winding a yarn so as to allow both tapes to be removed before applying an additional layer of reinforcing fibers, while avoiding any risk of the layer 17 relaxing.

Under such circumstances, the yarn is wound together with the tape 7a′ that is situated under the tape 7b′, so that it is always possible to begin by removing the tape 7b′ and then the tape 7a′ while leaving the yarn in place.

It is also possible to improve the manner in which the layers of reinforcing fibers are pressed down by means of a so-called “rotary calendering” operation on the layer(s) of reinforcing fibers, as shown diagrammatically in FIGS. 13 to 15.

As shown in FIG. 13, a rotary calendering apparatus, referenced 19, is then provided, which apparatus comprises a frame 21 that is mounted to rotate about the axis AX, the frame 21 being carried for example by an apparatus of the type shown in FIG. 3, and being rigidly secured to the ring of that apparatus.

The frame 12 carries a set of four wheels 22, 23, 24, and 25 that are situated in a common plane normal to the axis AX and around which a belt referenced 27 is engaged to form a member for pressing down the fibers. A portion of the belt 27 thus bears laterally against the assembly 6 constituted by the mandrel 2 and the layers of reinforcing fibers that it carries, thereby exerting a force on those layers that is directed radially relative to the axis AX.

Thus, when the frame 21 rotates about the axis AX, the portion of the belt that is bearing laterally against the assembly 6 turns around the axis AX but without generating circumferential tension in the layer 17 because the belt is turning simultaneously around the wheels 22 to 25, and thus around an axis parallel to the axis AX.

One or more of the various wheels 22 to 25 may be mounted on a system for giving the belt a certain amount of resilience in a radial direction relative to the frame. For this purpose, the apparatus has return means such as springs for adjusting the tension in the belt, i.e. the forces exerted radially by the belt on the assembly constituted by the mandrel and the layers that it carries.

In addition, and as shown in FIG. 14, another calendering apparatus 28 may be provided that is spaced apart from the apparatus 19 along the axis AX, this other calendering apparatus 28 being actuated to turn about the axis AX in the opposite direction to the apparatuses 19.

When using such a double calendering operation, it is ensured firstly that the pressing-down of the braid 17 on the mandrel 2 or on the other layers carried by the mandrel takes place very progressively, and secondly the amount of circumferential stress applied to the layer 17 is significantly reduced, once more as a result of the two calendering apparatuses 19 and 28 having opposing effects in terms of circumferential stress.

The braided layers are calendered by means of belts, however calendering could also be performed directly by means of wheels or rollers carried by a rotary frame and applied radially directly against the braided layers carried by the mandrel.

A calendering operation may be applied after each braided layer has been applied to the mandrel, after a plurality of layers have been applied, or indeed after all of the layers have been applied.

Furthermore, in the example shown in the figures, the calendering operations are implemented progressively as each layer of reinforcing fibers is deposited, thereby enabling the layers to be pressed down immediately.

The calendering operation(s) may be implemented either alone, or else in combination with the operations of winding ties around the braided layers.

When the calendering operations are implemented alone, provision may be made, for example, to calender each braided layer around the mandrel prior to installing the assembly constituted by the mandrel and the layers it carries in a mold in order to inject resin therein and in order to polymerize the resin.

When the calendering operations are implemented in combination with operations of winding ties or tapes, they enable the quality with which the braided fibers are pressed against the mandrel to be further increased by using an installation of the kind shown diagrammatically in FIG. 15.

Under such circumstances, after one or more layers have been braided around the mandrel, a single or double calendering operation is performed before applying a tie around the braided layers. The tie may be left in place or removed prior to fabricating another braided layer around the assembly.

To this end, the installation shown in FIG. 15 comprises, along the axis AX, firstly a braiding machine, then the two calendering apparatuses 19 and 28, and then one or two apparatuses for winding tapes onto the assembly 6.

The various apparatuses are spaced apart from one another along the axis AX so that the braiding and the application of the layer of reinforcing fibers, its calendering onto the mandrel 2, and the winding of one or more ties are all performed in a single stage during which the assembly 6 travels along the axis AX.

In general, it is appropriate to observe that the examples shown in the figures represent situations in which the part made of composite material is formed by a first layer and a second layer.

Nevertheless, the method is equally applicable to parts having a much greater number of layers of reinforcing fibers. Under such circumstances, the winding of a tape and/or of a yarn may, as appropriate, be performed for pressing a single layer against the mandrel, or else it may be performed for pressing a set of layers of reinforcing fibers down together, which layers have been themselves applied by a plurality of passes through the braiding machine.

Furthermore, the ties that are used, i.e. the tapes and the yarns that are wound around the part that is being fabricated may, depending on circumstances, themselves be made out of the same fibers as the fibers that are used for making up the reinforcing layers themselves, i.e. typically carbon fibers, or else they may be made of some other material.

When the tie or the tape in question is to be left in place, it is advantageous to make provision for it to be made out of the same fibers as those used for braiding the layers of reinforcing fibers. However, when the yarn or the tape is to be removed during the fabrication method, it is equally possible to use materials other than fibers of the same type as the fibers used for the braided layers.

What is claimed is:

1. A method of fabricating a composite material part in which one or more layers (17, 18) of reinforcing fibers (4) that are braided or woven or else draped are applied onto a mandrel (2) that extends in a longitudinal direction (AX) and that presents a cross-section that is defined by a closed outline, wherein the method includes, after applying one or more layers (17) on the mandrel (2), an operation of applying at least one tie (7, 7a, 7b, 7′, 7a′, 7b′, 7″) that is wound helically around and along the assembly (6) constituted by the mandrel (2) and each layer (17) of reinforcing fibers (4) that it carries, in order to press each layer (17) of reinforcing fibers against the mandrel (2) and wherein a new layer (18) of reinforcing fibers is applied over one or more layers (17) on which at least one tie (7, 7a, 7b, 7′, 7a′, 7b′, 7″) has been wound, and wherein at least one tie (7, 7a, 7b, 7′, 7a′, 7b′) that has been wound is unwound so as to be removed progressively as the new layer(s) (18) is/are applied.

2. A method according to claim 1, wherein the tie (7, 7a, 7b, 7′, 7a′, 7b′) used is in the form of a tape, and is placed flat against the layers (17) of reinforcing fibers carried by the mandrel (2).

3. A method according to claim 1, wherein the consecutive turns of each wound tie (7, 7a, 7b, 7′, 7a′, 7b′, 7″) are spaced apart from one another.

4. A method according to claim 1, wherein the winding operation comprises winding a tie (7, 7a, 7b, 7′, 7a′, 7b′) in the form of a tape, and secondly winding a tie (7″) in the form of a yarn.

5. A method according to claim 4, wherein the tie in the form of a tape (7, 7a, 7b, 7′, 7a′, 7b′) is removed before applying a new layer (18) of reinforcing fibers.

6. A method according to claim 1, wherein at least two ties (7a′, 7b′) are wound in opposite directions around the assembly (6) constituted by the mandrel (2) and the layer(s) (17) of reinforcing fibers that it carries.

7. A method according to claim 1, wherein at least one tie (7, 7a, 7b, 7′, 7a′, 7b′, 7″) wound on the assembly (6) constituted by the mandrel (2) and the layers of reinforcing fibers (17) that it carries is constituted by fibers of the same kind as the reinforcing fibers (4) of the layers (17, 18) applied against the mandrel (2).

8. A method according to claim 1, wherein at least one tie (7, 7a, 7b, 7′, 7a′, 7b′, 7″) is wound around and along the assembly (6) progressively as a layer of reinforcing fibers is being deposited on the assembly (6).

9. A method of fabricating a composite material part in which one or more layers (17, 18) of reinforcing fibers (4) that are braided or woven or else draped are applied onto a mandrel (2) that extends in a longitudinal direction (AX) and that presents a cross-section that is defined by a closed outline, prior to injecting resin into said layers and polymerizing the resin, wherein, prior to injecting the resin, the method includes one or more operations of pressing each layer (17) of reinforcing fibers against the mandrel (2), each operation being performed by an apparatus (19, 28) having a frame (21) rotating about the mandrel (2) and carrying a presser member (27) applied at least in part radially against the assembly formed by the mandrel (2) and each layer (17, 18) that it carries, while being free to rotate relative to the frame (21) and around an axis parallel to the longitudinal direction (AX) so as to exert a pressing force against each layer (17) that is to be pressed down, which force is oriented radially relative to the longitudinal direction (AX).

10. A method according to claim 9, wherein the presser member (27) is a belt (27) engaged around a set of wheels (22, 25) carried by the frame (21), a portion of the belt being pressed laterally against a portion of the assembly (6) constituted by the mandrel (2) and each layer (17) that it carries.

11. A method according to claim 10, wherein pressing is performed by two apparatuses (19, 28) having respective frames rotating in opposite directions around the assembly (6) constituted by the mandrel (2) and each layer (17) that it carries.

12. A method according to claim 1, wherein at least one operation of pressing layers (17, 18) of reinforcing fibers is implemented progressively as a layer (17, 18) of reinforcing fibers is being deposited on the assembly (6).
